(19) United States
(12) Patent Application Publication
(10) Pub. No.: US 2020/0183668 A1
(43) Pub. Date: Jun. 11, 2020

(54) SYSTEM FOR CODE ANALYSIS BY STACKED DENOISING AUTOENCODERS

(71) Applicant: BANK OF AMERICA CORPORATION, Charlotte, NC (US)

(72) Inventor: Madhusudhanan Krishnamoorthy, Hasthinapuram (IN)

(73) Assignee: BANK OF AMERICA CORPORATION, Charlotte, NC (US)

(21) Appl. No.: 16/210,168

(22) Filed: Dec. 5, 2018

(51) Int. Cl. G06F 8/41; G06N 3/08; G06K 9/62

(52) U.S. Cl. CPC G06F 8/4435; G06K 9/6218; G06K 9/6215; G06N 3/088

(57) ABSTRACT

Embodiments of the invention are directed to systems, methods, and computer program products for cross-technology code analysis for redundancy identification and functionality recognition. In particular, the novel present invention provides a unique platform for analyzing software code across multiple coding language using a unique approach involving the use of denoising autoencoders. Embodiments of the inventions are configured to leverage a marginalized stacked denoising autoencoder approach to analyze software code, identify code redundancies, and improve efficiency for code storage and query ability by the use of a trained autoencoding module to autoencode software code attributes into vectorized data that can be compared to determine cross-platform functionality and redundancy within a software library.

### FIELD OF THE INVENTION

The present invention generally relates to the field of efficiency improvement for code analysis for redundancy identification and functionality recognition. In particular, the novel present invention provides a unique platform for analyzing software code across multiple coding language using a unique approach involving the use of denoising autoencoders. Embodiments of the inventions are configured to leverage a marginalized stacked denoising autoencoder approach to analyze software code, identify code redundancies, and improve efficiency for code storage and query ability.

### BACKGROUND

Current code analyzing tools for redundancy identification and functionality recognition tend to be deterministic in nature and lack the ability for analysis of multiple different variations of code representation. The output rules produced by such conventional solutions are often minimally effective and have a potential for producing unintended effects or unhelpful data analysis when unattended by comprehensive human review. Code language from various sources may be utilized to achieve a particular solution for a business or entity. In addition, convention approaches to code analysis lack functionality across multiple code languages and technologies. As such, analysis results often do not allow for direct comparison, and comparing redundancy identification and functionality recognition results requires the investment of additional manual effort. As such, a need exists for a solution to analyze multiple coding languages and technologies in a manner that allows for more efficient redundancy identification and functionality recognition with less human involvement and manual resources. Additionally, a need exists for increased storage efficiency and greater ability for comparison of analysis results between coding languages and technologies.

The previous discussion of the background to the invention is provided for illustrative purposes only and is not an acknowledgement or admission that any of the material referred to is or was part of the common general knowledge as at the priority date of the application.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention comprise systems, methods, and computer program products that address these and/or other needs by providing an innovative system, method and computer program product for user interface construction based on analysis, processing and assessment of software code functionality and redundancy. Typically the system comprises: at least one memory device with computer-readable program code stored thereon; at least one communication device; at least one processing device operatively coupled to the at least one memory device and the at least one communication device, wherein executing the computer-readable code is configured to cause the at least one processing device to: receive program data of a first program for analysis; autoencode the program data to obtain encoded program data, wherein the encoded program data comprises a numerical representation of the program data; vectorize the encoded program data, wherein vectorizing the program code comprises converting the encoded program data into a vector containing multiple vector dimensions; compare vectorized program code of the first program and vectorized program code of one or more additional programs and calculate a mathematical distance between the vectorized program code for the first program and the vectorized program code for the one or more additional programs; determine that the mathematical distance between the vectorized program code for the first program and the vectorized program code for the one or more additional programs is below a threshold value; and cluster the vectorized program code of the first program and vectorized program code of one or more additional programs based on determining that the mathematical distance between the vectorized program code for the first program and the vectorized program code for the one or more additional programs is below the threshold value.

In some embodiments, the autoencoding of program data further comprises: manipulating the program data by adding noise data to the program data resulting in artificially corrupted data; encoding the artificially corrupted data and decoding the artificially corrupted data, wherein decoding the artificially corrupted data further includes removing the added noise data to obtain decoded output data; and repeating the encoding and decoding of artificially corrupted data until the decoded output data converges on the value of the received program data, resulting in a trained autoencoding module.

In some embodiments, the trained autoencoding module further comprises multiple layers of autoencoding and decoding that are executed simultaneously.

In some embodiments, the system further comprises identifying redundancy and functional similarity of program attributes between the first program and the one or more additional programs based on the calculated mathematical distance between the vectorized program code for the first program and the vectorized program code for the one or more additional programs.

In some embodiments, the system further comprises calculating possible reduction in storage requirements based on the identified redundancy of program attributes.

In some embodiments, the system further comprises providing recommendations for storage reduction based on the calculated possible reduction in storage requirements.

In some embodiments, the system further comprises providing a user interface to a user that allows the user to query the clustered vectorized program code of the first program and vectorized program code of one or more additional programs to determine functional similarities between programs.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 depicts a system environment 100, in accordance with one embodiment of the present invention;

FIG. 2 depicts a high level process flow 200 for code analysis, in accordance with one embodiment of the present invention;

FIG. 3 depicts a process flow diagram for an autoencoding module 300, in accordance with one embodiment of the present invention; and

FIG. 4 depicts a process flow diagram for a code analysis platform 400, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

In some embodiments, an “entity” or “enterprise” as used herein may be any institution employing information technology resources and particularly technology infrastructure configured for large scale processing of electronic files, electronic technology event data and records, and performing/processing associated technology activities. In some instances, the entity's technology systems comprise multiple technology applications across multiple distributed technology platforms for large scale processing of technology activity files and electronic records. As such, the entity may be any institution, group, association, financial institution, establishment, company, union, authority or the like, employing information technology resources.

As described herein, a “user” is an individual associated with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer. In other embodiments, a user may be a system performing one or more tasks described herein.

In the instances where the entity is a financial institution, a user may be an individual or entity with one or more relationships affiliations or accounts with the entity (for example, a financial institution). In some embodiments, the user may be an entity or financial institution employee (e.g., an underwriter, a project manager, an IT specialist, a manager, an administrator, an internal operations analyst, bank teller or the like) capable of operating the system described herein. In some embodiments, a user may be any individual or entity who has a relationship with a customer of the entity or financial institution. For purposes of this invention, the term “user” and “customer” may be used interchangeably. A “technology resource” or “account” may be the relationship that the user has with the entity. Examples of technology resources include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The technology resource is typically associated with and/or maintained by an entity.

As used herein, a “user interface” or “UI” may be an interface for user-machine interaction. In some embodiments the user interface comprises a graphical user interface. Typically, a graphical user interface (GUI) is a type of interface that allows users to interact with electronic devices such as graphical icons and visual indicators such as secondary notation, as opposed to using only text via the command line. That said, the graphical user interfaces are typically configured for audio, visual and/or textual communication. In some embodiments, the graphical user interface may include both graphical elements and text elements. The graphical user interface is configured to be presented on one or more display devices associated with user devices, entity systems, processing systems and the like. In some embodiments the user interface comprises one or more of an adaptive user interface, a graphical user interface, a kinetic user interface, a tangible user interface, and/or the like, in part or in its entirety.

As used herein, a “program” includes a series of coded software instructions to control the operation of a computer or other machine. A “function” or “program function,” as used herein, is a section of a program that performs a specific task. In this sense, a function is a type of procedure or routine. Some programming languages make a distinction between a function, which returns a value, and a procedure, which performs some operation but does not return a value; however, it is understood that embodiments of the invention may refer to the term “function” to represent either of these operations. A “variable,” as used herein is a value that can change, depending on conditions or on information passed to the program. Typically, a program consists of instruction s that tell the computer what to do and data that the program uses when it is running. The data consists of constants or fixed values that never change and variable values (which are usually initialized to “0” or some default value because the actual values will be supplied by a program's user). Usually, both constants and variables are defined as certain data types. Each data type prescribes and limits the form of the data. Examples of data types include: an integer expressed as a decimal number, or a string of text characters, usually limited in length. In object-oriented programming, each object contains the data variables of the class it is an instance of. The object's method s are designed to handle the actual values that are supplied to the object when the object is being used.

As used herein, an “autoencoder” is a type of artificial neural network used to learn efficient data codings in an unsupervised manner. The aim of an autoencoder is to learn a representation, or “encoding” for a set of data, typically for dimensionality reduction. In some embodiments, the encoded data is further processed or “vectorized” to produce a vector containing a certain number of dimensions. In some embodiments, the vectorized data may be compared to determine a similarity between the underlying data that the vectors represent.

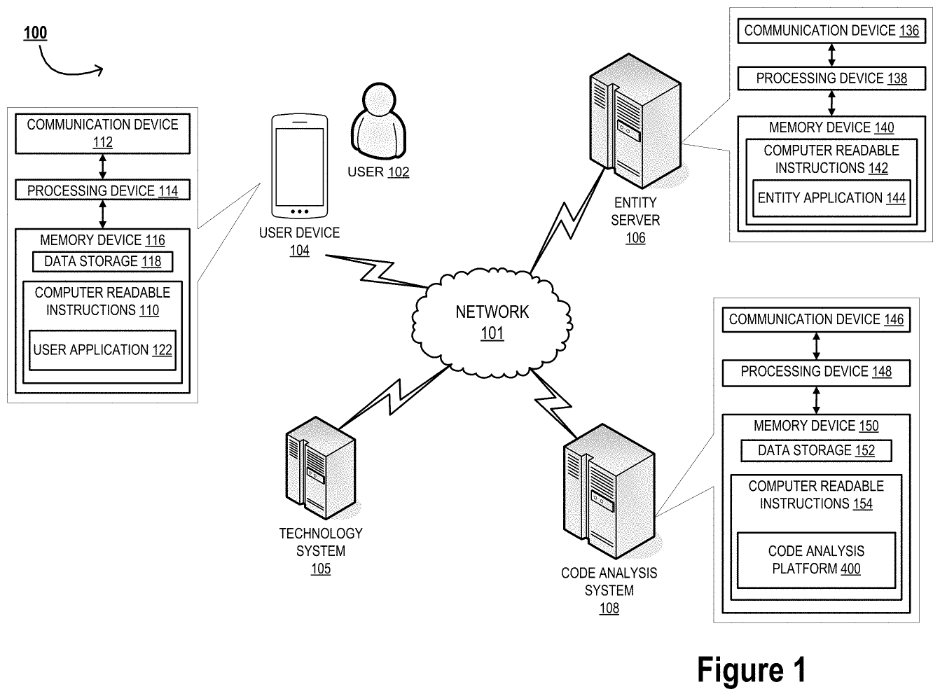

FIG. 1 illustrates a system environment 100, in accordance with some embodiments of the present invention. As illustrated in FIG. 1, a code analysis system 108 is operatively coupled, via a network 101 to a user device 104, to an entity server 106, and to a technology system 105. In this way, the code analysis system 108 can send information to and receive information from the user device 104, the entity server 106, and the technology system 105. FIG. 1 illustrates only one example of an embodiment of the system environment 100, and it will be appreciated that in other embodiments one or more of the systems, devices, or servers may be combined into a single system, device, or server, or be made up of multiple systems, devices, or servers. In this way, the code analysis system 108, is configured for receiving software code for analysis, performing code analysis using a deep learning algorithm, encoding software program attributes into vectorized representational components, and populating database to further assess and compare program functionalities and redundancies in an efficient manner.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the user 102 may be one or more individuals or entities that may either provide software code for analysis, query the code analysis system 108 for identified program attributes, set parameters and metrics for data analysis, and/or receive/utilize alerts created and disseminated by the code analysis system 108. As such, in some embodiments, the user 102 may be associated with the entity and/or a financial institution. In other embodiments, the user 102 may be associated with another system or entity, such as technology system 105, which may be a third party system which is granted access to the code analysis system 108 or entity server 106 in some embodiments.

FIG. 1 also illustrates a user system 104. The user device 104 may be, for example, a desktop personal computer, a mobile system, such as a cellular phone, smart phone, personal data assistant (PDA), laptop, or the like. The user device 104 generally comprises a communication device 112, a processing device 114, and a memory device 116. The user device 104 is typically a computing system that is configured to enable user and device authentication for access to technology event data. The processing device 114 is operatively coupled to the communication device 112 and the memory device 116. The processing device 114 uses the communication device 112 to communicate with the network 101 and other devices on the network 101, such as, but not limited to, the entity server 106, the code analysis system 108 and the technology system 105. As such, the communication device 112 generally comprises a modem, server, or other device for communicating with other devices on the network 101.

The user device 104 comprises computer-readable instructions 110 and data storage 118 stored in the memory device 116, which in one embodiment includes the computer-readable instructions 110 of a user application 122. In some embodiments, the code analysis system 108 and/or the entity system 106 are configured to cause the processing device 114 to execute the computer readable instructions 110, thereby causing the user device 104 to perform one or more functions described herein, for example, via the user application 122 and the associated user interface.

As further illustrated in FIG. 1, the code analysis system 108 generally comprises a communication device 146, a processing device 148, and a memory device 150. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device, such as the processing device 148, typically includes functionality to operate one or more software programs, based on computer-readable instructions thereof, which may be stored in a memory device, for example, executing computer readable instructions 154 or computer-readable program code 154 stored in memory device 150 to perform one or more functions associated with the code analysis system 108.

The processing device 148 is operatively coupled to the communication device 146 and the memory device 150. The processing device 148 uses the communication device 146 to communicate with the network 101 and other devices on the network 101, such as, but not limited to the entity server 106, the technology system 105, and the user system 104. As such, the communication device 146 generally comprises a modem, server, or other device for communicating with other devices on the network 101.

As further illustrated in FIG. 1, the code analysis system 108 comprises the computer-readable instructions 154 stored in the memory device 150, which in one embodiment includes the computer-readable instructions for the implementation of a code analysis platform 400. In some embodiments, the computer readable instructions 154 comprise executable instructions associated with the code analysis platform 400, wherein these instructions, when executed, are typically configured to cause the applications or modules to perform/execute one or more steps described herein. In some embodiments, the memory device 150 includes data storage 152 for storing data related to the system environment, but not limited to data created and/or used by the code analysis platform 400 and its components/modules. The code analysis platform 400 is further configured to perform or cause other systems and devices to perform the various steps in processing software code, and organizing data as will be described in detail later on.

As such, the processing device 148 is configured to perform some or all of the data processing and event capture, transformation and analysis steps described throughout this disclosure, for example, by executing the computer readable instructions 154. In this regard, the processing device 148 may perform one or more steps singularly and/or transmit control instructions that are configured to the code analysis platform 400, entity server 106, user device 104, and technology system 105 and/or other systems and applications, to perform one or more steps described throughout this disclosure. Although various data processing steps may be described as being performed by the code analysis platform 400 and/or its components/applications and the like in some instances herein, it is understood that the processing device 148 is configured to establish operative communication channels with and/or between these modules and applications, and transmit control instructions to them, via the established channels, to cause these module and applications to perform these steps.

Embodiments of the code analysis system 108 may include multiple systems, servers, computers or the like maintained by one or many entities. FIG. 1 merely illustrates one of those systems 108 that, typically, interacts with many other similar systems to form the information network. In one embodiment of the invention, the code analysis system 108 is operated by the entity associated with the entity server 106, while in another embodiment it is operated by a second entity that is a different or separate entity from the entity server 106. In some embodiments, the entity server 106 may be part of the code analysis system 108. Similarly, in some embodiments, the code analysis system 108 is part of the entity server 106. In other embodiments, the entity server 106 is distinct from the code analysis system 108.

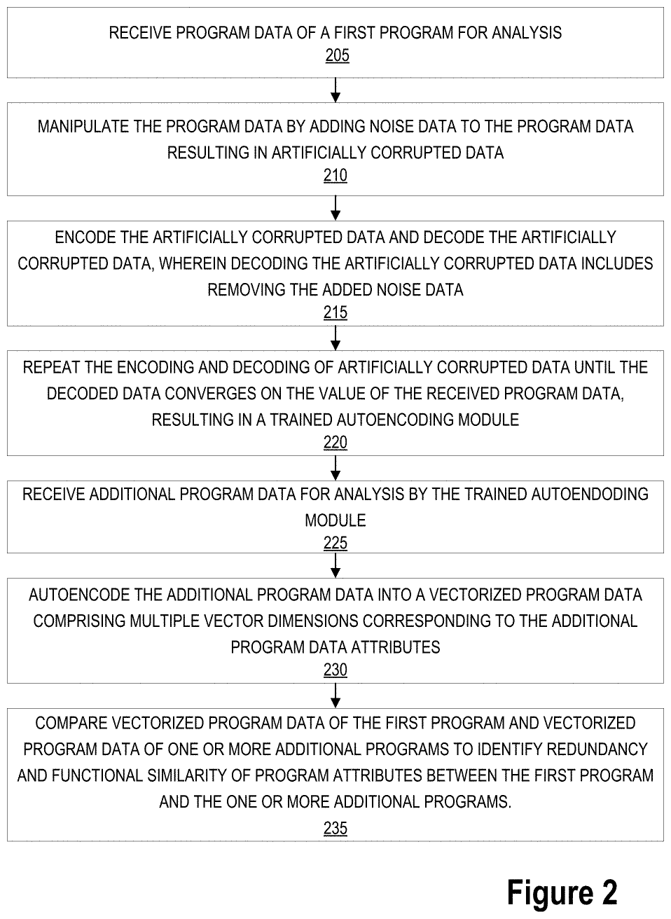

In one embodiment of the code analysis system 108, the memory device 150 stores, but is not limited to, the code analysis platform 400 as will be described later on with respect to FIG. 2. In one embodiment of the invention, the code analysis platform 400 may associated with computer-executable program code that instructs the processing device 148 to operate the network communication device 146 to perform certain communication functions involving the technology system 105, the user device 104 and/or the entity server 106, as described herein. In one embodiment, the computer-executable program code of an application associated with the code analysis platform 400 may also instruct the processing device 148 to perform certain logic, data processing, and data storing functions of the application.

The processing device 148 is configured to use the communication device 146 to receive data, such as open source software code, metadata associated with software code or software libraries, transmit and/or cause display of constructed knowledge graphs, UIs and the like. In the embodiment illustrated in FIG. 1 and described throughout much of this specification, the code analysis platform 400 may perform one or more of the functions described herein, by the processing device 148 executing computer readable instructions 154 and/or executing computer readable instructions associated with one or more application(s)/devices/components of the code analysis platform 400.

As illustrated in FIG. 1, the entity server 106 is connected to the code analysis system 108 and may be associated with a financial institution network. In this way, while only one entity server 106 is illustrated in FIG. 1, it is understood that multiple network systems may make up the system environment 100 and be connected to the network 101. The entity server 106 generally comprises a communication device 136, a processing device 138, and a memory device 140. The entity server 106 comprises computer-readable instructions 142 stored in the memory device 140, which in one embodiment includes the computer-readable instructions 142 of an institution application 144. The entity server 106 may communicate with the code analysis system 108. The code analysis system 108 may communicate with the entity server 106 via a secure connection generated for secure encrypted communications between the two systems for communicating data for processing across various applications.

As further illustrated in FIG. 1, in some embodiments, the threat intelligence forest system environment 100 further comprises a technology system 105, in operative communication with the code analysis system 108, the entity server 106, and/or the user device 104. Typically, the technology system 105 comprises a communication device, a processing device and memory device with computer readable instructions. In some instances, the technology system 105 comprises a first database/repository comprising software code or program component objects, and/or a second database/repository comprising functional source code associated with software or program component objects and attributes. These applications/databases may be operated by the processor executing the computer readable instructions associated with the technology system 105, as described previously. In some instances, the technology system 105 is owned, operated or otherwise associated with third party entities, while in other instances, the technology system 105 is operated by the entity associated with the systems 108 and/or 106. Although a single external technology system 105 is illustrated, it should be understood that, the technology system 105 may represent multiple technology servers operating in sequentially or in tandem to perform one or more data processing operations.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 2 depicts a high level process flow 200 for code analysis, in accordance with one embodiment of the present invention. As shown, the process flow begins at block 205, wherein the system receives program data of a first program for analysis. In some embodiments, this program data may include software code or metadata describing attributes of the software program. It is understood that the system 108 may receive and interact with software code in a number of different programming languages, such as, for example, Java, Perl, Smalltalk, C++, SAS, SQL, Python, Objective C, and/or the like. Next, the process proceeds to block 210, wherein the received program data is manipulated by an autoencoding neural network architecture. In some embodiments, the neural network architecture may include a denoising autoencoding architecture, or a stacked denoising autoencoding architecture. These neural network autoencoding architectures are trained by adding artificial noise, or meaningless data, to received raw input data, and attempting to decode the data by predicting the raw input and removing the noise. In this way, the neural network may repeat the denoising process until a convergence between raw input and decoded or “denoised” data is achieved. By incorporating this pre-training regime, the architecture learns certain statistical weights and biases to apply during the encoding process that are more accurate than random initialization.

In some embodiments, the neural network autoencoding architecture may be “stacked,” and include multiple successive layers of autoencoding acting on the input data in order to improve accuracy. Furthermore, in some embodiments, the neural network architecture may be a marginalized stacked denoising autoencoding module, wherein the architecture processes multiple layers by balancing priority of processing power to learn a single layer at a time, which may improve speed and performance. As shown in block 215, the process proceeds by encoding the artificially corrupted data and decoding the artificially corrupted data, wherein decoding the artificially corrupted data includes removing the added noise data to predict the input, or received, program data. It is understood that in some embodiments, as discussed previously, this process may include several rounds of denoising, as would be the case for a marginalized stacked denoising autoencoding neural network architecture.

As shown at block 220, the process is repeated by the autoencoding architecture until a convergence between the raw input, or received program data, and the decoded data is achieved, effectively resulting in a trained neural network autoencoding architecture. Next, the process receives additional program data for analysis by the trained autoencoding module, as shown in block 225. The additional program data is autoencoded to produce vectorized program code comprising multiple vector dimensions corresponding to various attributes of the program data, as shown in block 230. The program attributes represented by vector dimensions may include words, phrases, lines of code, paragraphs, and the like. In some embodiments, the autoencoder may be configured to vectorize received program data into any number of vector dimensions. For instance, the user 102, system administrator, or other authorized user may configure the system to use 300 vector dimensions. In other embodiments, a vector dimension value of 400, 500, and so forth may be used, depending on the level of detail required by the particular use-case of the system.

Finally, as shown in block 235 of FIG. 2, the vectorized program code of multiple programs may be compared in order to identify redundancy and functional similarity of program attributes. In this way, the autoencoded data may be automatically compared and analyzed by the system in order to identify redundancies, and functional similarities between programs within a library of programs. In this way, the system leverages the power of neural network autoencoders to performs the unsupervised learning techniques and identify, analyze, extract patterns and redundancies in code language. In this way, redundancy analysis can be achieved with accuracy of 99%, leading to effective storage reduction along with cross-platform functional similarity.

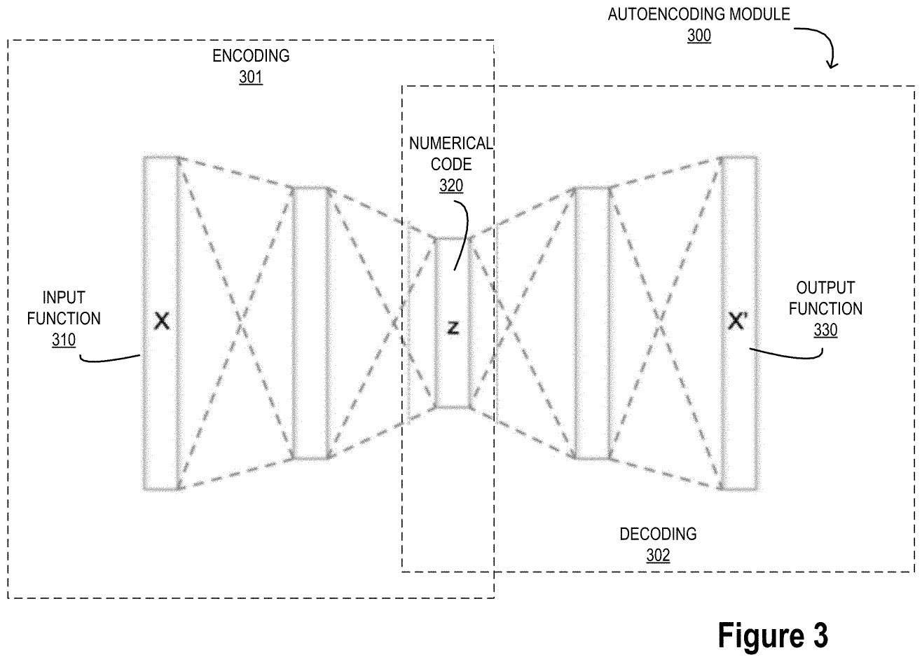

FIG. 3 depicts a process flow diagram for an autoencoding module 300, in accordance with one embodiment of the present invention. The autoencoding module 300 is employed as a means to produce numerical code from program syntax in order to allow vectorization of program functions. Embodiments of the invention may employ a variety of different autoencoding mechanisms, including denoising autoencoders, stacked denoising autoencoders, and marginalized stacked denoising autoencoders. FIG. 3 depicts the basic process flow for autoencoding, including encoding step 301 and decoding step 302. During the encoding step 301, an input function 310 is received by the autoencoding module 300, and is represented as a value “X”. The function received by the autoencoding module 300 may vary according to the application of the autoencoding module 300, and may include various program attributes such as words, phrases, lines of code, paragraphs, code variables, an identified function within the program, a string of identified functions, and the like. In a basic autoencoding process, this value X is encoded into a numerical code 320, as represented by “Z”. The autoencoding module 300 then decodes the numerical value Z to arrive at the output function 330 as represented by “X′”. Ideally, the decoded value for X′ should match the input function 310, or X.

In some embodiments, the autoencoding module 300 involves a denoising autoencoding process, wherein noise or random data is added to the input function 310 before it is encoded into numerical code 320. In the denoising autoencoding process, decoding step 302 involves removal of the added noise in order to predict the correct value for the input function 310. Through iterative loops of denoising autoencoding, the output function 330 is compared to the input function 310 until the autoencoding module 300 can successfully predict the correct value for the input function 310. This offers an advantage over the general autoencoding process by allowing the autoencoding module 300 to separate the added noise from the input function 310 data. The iterative looping of denoising autoencoding allows the autoencoding module 300 to be trained to decode an output function 310 with a high degree of confidence that the output function 310 represents critical data.

In some embodiments, the autoencoding module 300 involves a stacked denoising autoencoding process, which is used to improve the speed of the denoising autoencoding process by stacking several layers of autoencoding that may be executed simultaneously. In other embodiments, the autoencoding module 300 involves a marginalized stacked denoising autoencoding process (“MSDA”), wherein the stacked layers of denoising autoencoding are balanced based on priority in order to optimize computational resources and further improve the speed of the overall autoencoding process. At any point within the MSDA process, several layers may be dormant, while other active layers are processed.

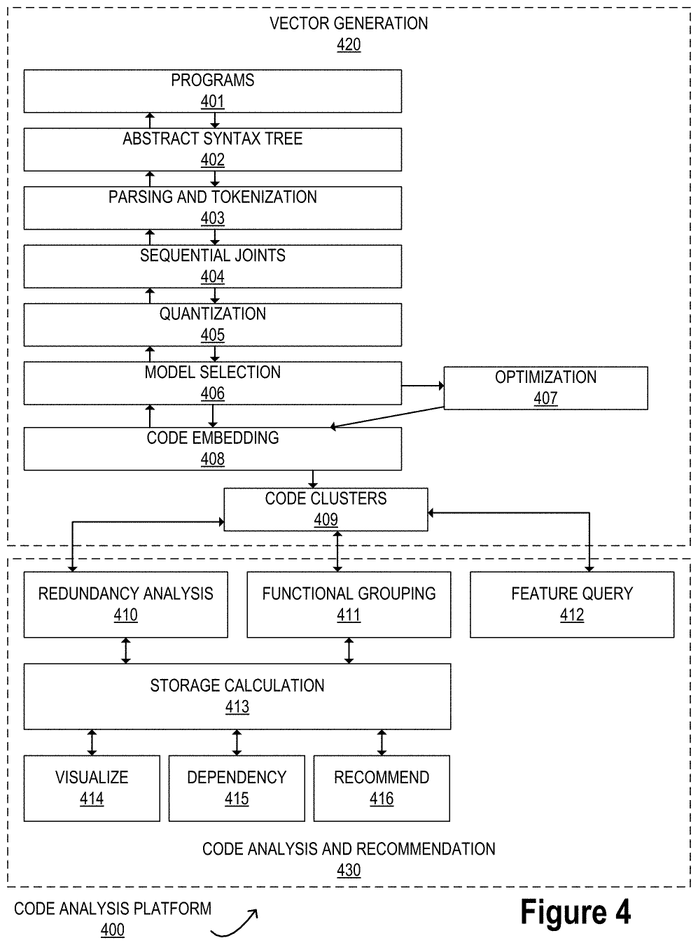

FIG. 4 depicts a process flow diagram for a code analysis platform 400, in accordance with one embodiment of the present invention. As shown, the code analysis platform 400 begins with vector generation 420, wherein program code is processed, vectorized, and eventually organized for further analysis downstream at the code analysis and recommendation layer 430. First, programs 401 are received by the code analysis platform 400 and converted into abstract syntax tree 402. Abstract syntax tree 402 is a representation of the abstract syntactic structure of program code written in any given programming language. Each node of the “tree” denotes a construct occurring in the program code. In this way, the abstract syntax tree 402 is used to indicate the various functions used in the program. For instance, the abstract syntax tree 402 may include a node for any number of program features, including variables used in the program, functions used in the program, and the linkage of various functions that may rely on one another for the program to function. The abstract syntax tree 402 may be created for any program received by the code analysis platform 400, and may be constructed for any object-oriented, scripted, and/or unscripted programming languages, such as, for example, Java, Perl, Smalltalk, C++, SAS, SQL, Python, Objective C, and/or the like.

Once the program features have been mapped in the abstract syntax tree 402, the code analysis platform converts the data contained in the abstract syntax tree 402 using parsing an tokenization 403. During parsing and tokenization 403, the unique variables used in the programs 401 are removed or replaced such that only the underlying functions themselves are retained. Next, sequential joints 404 are created based on the parsed and tokenized data in the abstract syntax tree 402. The sequential joints 404 represent groups of functions based on how the functions flow together and interact with one another in the program code. Individual functions are joined together to create sequential joints 404 that may be further processed as a group.

Next, the code analysis platform 400 proceeds to quantization 405, wherein the autoencoding module 300 is applied to the sequential joint 404 data to produce numerical code. As discussed in the description of FIG. 3, a particular model of autoencoding is selected, and may vary according to the embodiment of the invention, as represented by model selection 406. In some embodiments, the model selection may include denoising autoencoding, stacked denoising autoencoding, and marginalized stacked denoising autoencoding. The model selection may further include selection of any machine learning model, such as tensorflow or the like, to enable the iterative optimization 407 of the autoencoding module. The process is optimized as shown by optimization 407 to produce output functions 330 that match the input functions 310, or in other words to ensure that the data produced by the autoencoding module 300 represents only critical data. Next, the process moves to code embedding 408, which represents the vectorization of encoded data Z. As shown, code embedding 408 maintains a feedback data loop to programs 401 in order to ensure that vectorized data accurately represents the program features identified in programs 401. The resulting vectorized program code contains 300-500 vector code embeddings or vector dimensions that represent each of the encoded program features. For instance, in some embodiments, one sequential joint 404 may be encoded and vectorized to produce a representative 300 dimension vectorized program code embedding.

As indicated by code clusters 409, the code embeddings 408 may be compared and grouped based on calculated distance between vectorized program code embeddings. It is understood that as the mathematical distance between vectorized program code embeddings approaches zero, this is an indication that the program functions represented by the vectorized program code embeddings are performing the same or similar functions. As previously discussed, the received programs 401 may contain code from a variety of different program languages. However, regardless of the program language used in the original programs 401, the vectorized program code embeddings may be used to calculate a mathematical distance and determine functional similarity. As, such, the code analysis platform is able to identify functional similarity across any variety of program coding languages and platforms.

Based on the calculated mathematical distance between vectorized program code embeddings, the code analysis platform 400 clusters similar code embeddings 408, and may attach metadata to these code clusters 409 indicating the underlying programs 401 which were processed to create the code embeddings 408. This metadata may include the program name, location at which the function appears in the abstract syntax tree 402 for a particular program, related program functions, storage size for the original program function, and any other information that may be relevant to a particular use case. Several use cases are outlined in code analysis and recommendation layer 430, but it is understood that additional use cases may exist based on information known about the programs 401.

As shown in FIG. 4, the code clusters 409 may be used to perform redundancy analysis 401, functional grouping 411, and feature query 412. Redundancy analysis 410 includes identifying code clusters 409 that indicate multiple programs 401 which are performing the same function as indicated by the relatively small mathematical distance in the vectorized program code embeddings. Similarly, the code analysis platform 400 may group the code clusters together in order to convey functional similarity between programs and program features, as shown by functional grouping 411.

In some embodiments, the code analysis platform 400 may be configured to automatically perform redundancy analysis 410 and functional grouping 411. Additionally, in some embodiments, the code analysis platform 400 may be access via a user application 122 or other user interface such that the user 102 may query the code analysis platform 400 based on a particular function or program feature in order to obtain information about redundancy and functional similarity within the analyzed programs 401. The code analysis platform 400 also generates a storage calculation 413, which may be used to visualize current storage requirements of analyzed programs 401, as represented by visualize 414. Storage calculation 413 may also use data known inter-program dependency, as shown by dependency 415, in order to determine the functional dependency between programs 401 in a given platform. Using this information, the code analysis platform 400 may make recommendations for reducing redundancy within programs and optimizing or reducing storage requirements, as indicated by recommend 416.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for cross-technology code analysis, the system comprising:
at least one memory device with computer-readable program code stored thereon;
at least one communication device;
at least one processing device operatively coupled to the at least one memory device and the at least one communication device, wherein executing the computer-readable code is configured to cause the at least one processing device to:
receive program data of a first program for analysis;
autoencode the program data to obtain encoded program data, wherein the encoded program data comprises a numerical representation of the program data;
vectorize the encoded program data, wherein vectorizing the program code comprises converting the encoded program data into a vector containing multiple vector dimensions;
compare vectorized program code of the first program and vectorized program code of one or more additional programs and calculate a mathematical distance between the vectorized program code for the first program and the vectorized program code for the one or more additional programs;
determine that the mathematical distance between the vectorized program code for the first program and the vectorized program code for the one or more additional programs is below a threshold value; and
cluster the vectorized program code of the first program and vectorized program code of one or more additional programs based on determining that the mathematical distance between the vectorized program code for the first program and the vectorized program code for the one or more additional programs is below the threshold value.

2. The system of claim 1, wherein the autoencoding of program data further comprises:
manipulating the program data by adding noise data to the program data resulting in artificially corrupted data;
encoding the artificially corrupted data and decoding the artificially corrupted data, wherein decoding the artificially corrupted data further includes removing the added noise data to obtain decoded output data; and
repeating the encoding and decoding of artificially corrupted data until the decoded output data converges on the value of the received program data, resulting in a trained autoencoding module.

3. The system of claim 2, wherein the trained autoencoding module further comprises multiple layers of autoencoding and decoding that are executed simultaneously.

4. The system of claim 1, further comprising identifying redundancy and functional similarity of program attributes between the first program and the one or more additional programs based on the calculated mathematical distance between the vectorized program code for the first program and the vectorized program code for the one or more additional programs.

5. The system of claim 4, further comprising calculating possible reduction in storage requirements based on the identified redundancy of program attributes.

6. The system of claim 5 further comprising providing recommendations for storage reduction based on the calculated possible reduction in storage requirements.

7. The system of claim 1, further comprising providing a user interface to a user that allows the user to query the clustered vectorized program code of the first program and vectorized program code of one or more additional programs to determine functional similarities between programs.

8. A computer program product for cross-technology code analysis with at least one non-transitory computer-readable medium having computer-readable program code portions embodied therein, the computer-readable program code portions comprising:
an executable portion configured to receive program data of a first program for analysis;
an executable portion configured to autoencode the program data to obtain encoded program data, wherein the encoded program data comprises a numerical representation of the program data;
an executable portion configured to vectorize the encoded program data, wherein vectorizing the program code comprises converting the encoded program data into a vector containing multiple vector dimensions;
an executable portion configured to compare vectorized program code of the first program and vectorized program code of one or more additional programs and calculate a mathematical distance between the vectorized program code for the first program and the vectorized program code for the one or more additional programs;
an executable portion configured to determine that the mathematical distance between the vectorized program code for the first program and the vectorized program code for the one or more additional programs is below a threshold value; and
an executable portion configured to cluster the vectorized program code of the first program and vectorized program code of one or more additional programs based on determining that the mathematical distance between the vectorized program code for the first program and the vectorized program code for the one or more additional programs is below the threshold value.

9. The computer program product of claim 8, wherein the autoencoding of program data further comprises:
manipulating the program data by adding noise data to the program data resulting in artificially corrupted data;
encoding the artificially corrupted data and decoding the artificially corrupted data, wherein decoding the artificially corrupted data further includes removing the added noise data to obtain decoded output data; and
repeating the encoding and decoding of artificially corrupted data until the decoded output data converges on the value of the received program data, resulting in a trained autoencoding module.

10. The computer program product of claim 9, wherein the trained autoencoding module further comprises multiple layers of autoencoding and decoding that are executed simultaneously.

11. The computer program product of claim 8, further comprising identifying redundancy and functional similarity of program attributes between the first program and the one or more additional programs based on the calculated mathematical distance between the vectorized program code for the first program and the vectorized program code for the one or more additional programs.

12. The computer program product of claim 11, further comprising calculating possible reduction in storage requirements based on the identified redundancy of program attributes.

13. The computer program product of claim 12, further comprising providing recommendations for storage reduction based on the calculated possible reduction in storage requirements.

14. The computer program product of claim 8 further comprising providing a user interface to a user that allows the user to query the clustered vectorized program code of the first program and vectorized program code of one or more additional programs to determine functional similarities between programs.

15. A computer-implemented method for cross-technology code analysis, the method comprising:
receiving program data of a first program for analysis;
autoencoding the program data to obtain encoded program data, wherein the encoded program data comprises a numerical representation of the program data;
vectorizing the encoded program data, wherein vectorizing the program code comprises converting the encoded program data into a vector containing multiple vector dimensions;
comparing vectorized program code of the first program and vectorized program code of one or more additional programs and calculate a mathematical distance between the vectorized program code for the first program and the vectorized program code for the one or more additional programs;
determining that the mathematical distance between the vectorized program code for the first program and the vectorized program code for the one or more additional programs is below a threshold value; and
clustering the vectorized program code of the first program and vectorized program code of one or more additional programs based on determining that the mathematical distance between the vectorized program code for the first program and the vectorized program code for the one or more additional programs is below the threshold value.

16. The computer-implemented method of claim 15, wherein the autoencoding of program data further comprises:
manipulating the program data by adding noise data to the program data resulting in artificially corrupted data;
encoding the artificially corrupted data and decoding the artificially corrupted data, wherein decoding the artificially corrupted data further includes removing the added noise data to obtain decoded output data; and
repeating the encoding and decoding of artificially corrupted data until the decoded output data converges on the value of the received program data, resulting in a trained autoencoding module.

17. The computer-implemented method of claim 16, wherein the trained autoencoding module further comprises multiple layers of autoencoding and decoding that are executed simultaneously.

18. The computer-implemented method of claim 15, further comprising identifying redundancy and functional similarity of program attributes between the first program and the one or more additional programs based on the calculated mathematical distance between the vectorized program code for the first program and the vectorized program code for the one or more additional programs.

19. The computer-implemented method of claim 18, further comprising calculating possible reduction in storage requirements based on the identified redundancy of program attributes.

20. The computer-implemented method of claim 19, further comprising providing recommendations for storage reduction based on the calculated possible reduction in storage requirements.
